(19) United States
(12) Patent Application Publication
(10) Pub. No.: US 2017/0076341 A1
(43) Pub. Date: Mar. 16, 2017

(54) Automated System and Method for Validating Ruled-Based Scripts and Generating Regional-Based Pricing Dependent on Product Configuration

(71) Applicant: Autodata Solutions, Inc., El Segundo, CA (US)

(72) Inventor: Hans Otten, London (CA)

(21) Appl. No.: 15/265,772

(22) Filed: Sep. 14, 2016

Related U.S. Application Data
(60) Provisional application No. 62/219,047, filed on Sep. 15, 2015.

(51) Int. Cl. G06Q 30/02; G06F 17/30

(52) U.S. Cl. CPC G06Q 30/0283; G06F 17/30864

(57) ABSTRACT

An automated pricing system for real-time generation of overall product costs based on product cost and regional secondary costs is described. The automated pricing system features at least processor and a memory communicatively coupled to the processor. The memory further features logic that, when executed by the processor, generates an overall pricing for a product in real-time based on properties of the product and a geographic region in which a purchase of the product is to occur. Such information for automated formation of the overall pricing of the product is extracted from an incoming message, which includes an identifier of the product and an identifier of the geographic region.

### CROSS-REFERENCE TO RELATED APPLICATIONS

This application claims the benefit of priority on U.S. Provisional Application No. 62/219,047 filed Sep. 15, 2015, the entire contents of which are incorporated herein by reference.

### FIELD

Embodiments of the disclosure relate to the field of automated networking system. More specifically, one embodiment of the disclosure relates to a rule-based, automated pricing system for enhanced and real-time price determination based on product configuration.

### GENERAL BACKGROUND

Many geographic regions in the world impose taxes on purchases of products or services. The taxation rules vary significantly among different countries. In fact, the taxation rules can vary between different areas in the same country. For global companies, operating internationally on a large scale, compliance with regional tax rules and pricing laws is a daunting task, especially in the automotive industry where the tax and pricing rules depend on many variables and change frequently.

For example, a new vehicle sold in certain areas of Europe is subject to secondary costs such as regional taxes and other environmental fees. For accurate pricing of a vehicle, these taxes and fees need to be considered. However, many of these taxes and environmental fees are driven by the particular components of the vehicle. For instance, an environmental cost may depend on the engine type of the vehicle or its tire size. Similarly, a carbon dioxide (CO₂) malus may depend on emissions levels of the vehicle.

With millions of vehicles being sold, and potentially thousands of vehicle permutations, vehicle manufacturers are unable to provide their dealers in multiple regions with real-time, accurate pricing. In fact, due to the complexity involved, some dealers are simply not displaying tax or environment specific pricing, which may violate pricing laws in those regions. Rather, these dealers are simply relying on a selected final price without any capability of providing real-time pricing adjustments, either favorable or unfavorable for the customer, due to changes in taxes and environment fees that may be related to different components present in a vehicle.

In short, common issues that arise without real-time pricing adjustments include a misrepresentation of pricing of a vehicle in a region because there was no consideration as to how the vehicle was built (i.e., in some countries, certain types of engines may be assigned a lower tax than other engines in the same country, and likewise, these engines may not experience the same tax incentives in different regions). Other issues that may arise, include (i) an inability to accurately represent to the consumer all the applied taxes and environment fees, often leading to consumer frustration and inaccurate pricing; (ii) an inability to automatically update pricing based on new tax and pricing laws or changes in vehicle content and/or content pricing, often over pricing vehicles to what the consumer should actually pay; and (iii) the existence of decentralized pricing managed by disperse geographically located groups who are often uninformed as to changes in tax rates and environmental fees, changes in prices of vehicle component, or varied pricing of a component of a vehicle when another component is also present in the vehicle.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is an exemplary embodiment of a centralized, automated pricing system.

FIG. 2 is an exemplary block diagram of a logical representation of the automated pricing system of FIG. 1.

FIG. 3 is an exemplary embodiment of the operational flow of the automated pricing system of FIG. 1.

FIG. 4A is an exemplary embodiment of a region-based price aggregation set for a particular geographic region that is used to produce a region pricing script.

FIG. 4B is an exemplary embodiment of a vehicle-based price aggregation set for a specific vehicle that is used to produce a vehicle pricing script.

FIG. 5 is an exemplary embodiment of a pricing array for the vehicle that is returned as part of the response message.

FIG. 6 is an exemplary embodiment of returned pricing for selected features for inclusion in a response message.

### DETAILED DESCRIPTION

Various embodiments of the disclosure are directed to a customized, rule-based, automated pricing system for a real-time price determination of a product based on its configuration, which provides improved operability and decreased bandwidth requirements for enterprise networks associated with distributors of items being sold over a wide range of regions. The automated pricing system is configured to automatically compute the prices of a product taking into account regional costs and product configuration, without further user intervention and in real-time. Herein, a price is based on the product cost, inclusive of seller margins, along with secondary costs that include regional taxes, other prices, environmental fees, fees related to intended use and/or other costs associated with the product. With respect to certain products (e.g., automotive vehicles), the overall vehicle pricing may vary from region to region depending on the particular components (properties) of the vehicle and how these components affect the secondary costs for the geographic regions (e.g., different countries, districts, counties, provinces, cities and/or other prescribed geographic areas may have different secondary cost structures). The automated pricing system is configured to provide real-time delivery of detailed pricing for a vehicle being sold in different regions on a global basis, such as in multiple countries on one or more continents.

In general terms, the automated pricing system includes logic for use in computation of overall pricing for all types of products where secondary costs, such as regional taxes, environmental fees, and other any other requisite costs associated with the purchase of the product (e.g., insurance, mello-roos taxes and state property taxes for housing; Carbon Dioxide emission taxes (CO₂ Malus), transfer fees and/or value added tax for vehicles) are considered. For the sake of illustration, the automated pricing system is described for the automotive market, allowing automotive manufacturers to define vehicle pricing in all markets in the world while respecting region specific tax and other laws. The automated pricing system offers several unique capabilities including:

(1) an ability to use properties of the built vehicle (e.g. engine, transmission, wheels, etc.) to dynamically control the calculation;

(2) a defined, custom scripting language to allow the consumer to express complex decision trees that reference geographical, vehicle, and environment attributes to define a price column, which allows for quick updates based on changes in pricing requirements for a region;

(3) a component pricing module that allows the consumer to price vehicle components by market, by price type, and thus, vehicle components can be variably priced based on the selection of other components and local or global currencies;

(4) a compiler and validation service to optimize scripts for runtime calculations;

(5) a runtime interface to dynamically calculate pricing of a built vehicle for any geography; and

(6) a reverse-engineering pricing algorithm that can calculate all the variations in price of a single component based on price, environment, and tax rules.

According to one embodiment of the disclosure, the customized, automated pricing system comprises (i) script editor logic, (ii) script validation logic, (iii) script compiler logic, (iv) component pricing logic, and (v) price calculation logic for such automation, as described below. For this embodiment, the automated pricing system may be configured to operate as an Application Programming Interface (API) that, in response to receipt of a price assessment query message associated with a particular geographic region over a network, returns a response message including aggregate pricing information of the product for that particular geographic region. As an illustrative example, the price assessment query message may include input data that identifies the product being queried for pricing (e.g., a vehicle identification number “VIN” or a sequence of data including the vehicle type and a list of selected features of the vehicle) along with the geographic region in which the product will be purchased. The response message includes the aggregated pricing information of the product, such as a pricing array identifying the total cost of the product which includes the retail price along with applicable costs (e.g., net retail price) and each applicable tax and/or fee (or credit) that needs to be applied to a retail price of the particular product for compliance with specific tax and pricing laws for that geographic region.

With respect to vehicle (automotive) pricing, the automated pricing system may generate a response to price assessment query messages in real-time, as changes to the pricing or deployment of one or more vehicle components may influence the retail price differently between various regions. The difference in pricing, in most cases, is greater than the change in pricing of the vehicle component(s) alone. One reason is that certain taxes, fees and/or credits may vary greatly among the regions, and furthermore, may depend on the particular type of components forming the vehicle. Certain portions of the aggregate pricing information (e.g., pricing array), which may be included as part of the response message, may be downloaded to a web server that enables real-time vehicle pricing updates or may be imported into a print driver for generating window stickers or other physical instruments that are needed to illustrate the costs that produce the retail price.

### I. Terminology

In the following description, certain terminology is used to describe features of the invention. For example, in certain situations, the term “logic” and “component” are representative of hardware, firmware or software that is configured to perform one or more functions. As hardware, a component (or logic) may include circuitry having data processing or storage functionality. Examples of such circuitry may include, but are not limited or restricted to a hardware processor (e.g., microprocessor with one or more processor cores, a digital signal processor, a programmable gate array, a microcontroller, an application specific integrated circuit “ASIC”, etc.), a semiconductor memory, or combinatorial elements.

Alternatively, the component (or logic) may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “computing device” should be construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: a server, an endpoint device (e.g., a laptop, a smartphone, a tablet, a desktop computer, a netbook, a medical device, or any general-purpose or special-purpose, user-controlled electronic device); a mainframe; a router; or the like.

The term “interconnect” may be construed as a physical or logical communication path between two or more computing devices. For instance, the communication path may include wired and/or wireless transmission mediums. Examples of wired and/or wireless transmission mediums may include electrical wiring, optical fiber, cable, bus trace, a radio unit that supports radio frequency (RF) signaling, or any other wired/wireless signal transfer mechanism.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### II. General Architecture

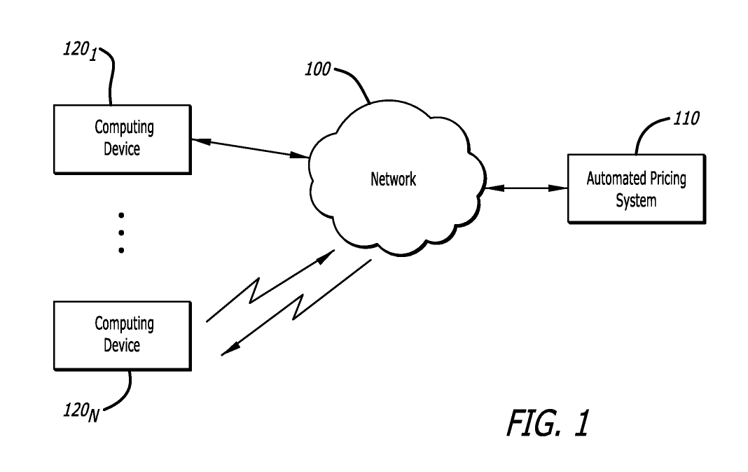

Referring to FIG. 1, an exemplary block diagram of a centralized, automated pricing system 110 deployed within a network 100 is described herein. Herein, the network 100 may be organized as a plurality of networks, such as a public network and/or a private network (e.g., an organization or enterprise network) that enable one or more computing devices 120₁-120_{N} (N≧1) to communicate with the automated pricing system 110. Each computing device 120₁ (i=1,2 . . . ) is configured to communicate with the automated pricing system 110 by exchanging messages (i.e., network traffic) with the automated pricing system 110 to acquire a detailed pricing layout for a product (e.g., an automotive vehicle) for any one of multiple countries. The messages may be in accordance with a predefined set of protocols, such as the Transmission Control Protocol/Internet Protocol (TCP/IP). However, it should be noted that other protocols, such as the HyperText Transfer Protocol (HTTP) or HTTP Secure (HTTPS) for example, may be advantageously used with the inventive aspects described herein.

According to an illustrative embodiment of the disclosure, in general, the automated pricing system 110 operates as a price calculation engine optimized for the automotive market, allowing vehicle manufacturers to define vehicle pricing in all or nearly all markets in the world while respecting region specific tax and legal laws. The data associated with vehicle pricing is returned with sufficient granularity to separately identify the pricing for a built vehicle (e.g., base vehicle, all optional features, etc.) and applicable secondary costs (e.g., taxes, fees and/or credits) on a designated area of a selected website or within a designated area of a physical “window sticker” for placement within the vehicle itself.

The automated pricing system 110 offers several unique capabilities. One capability involves the dynamic generation, in real-time, of the overall pricing for vehicles on a global scale, where the pricing is based, at least in part, on the properties (e.g., engine type, transmission type, tire size, etc.) of the built vehicle. These properties may affect the amount of secondary costs associated with the built vehicle (e.g., taxes imposed for a governmental entity within a particular region, fees imposed or credits awarded by the governmental entity, etc.). The dynamic generation of the overall pricing for the vehicle allows for thousands of different types of built vehicles to be price adjusted daily, with the capability for price adjustment of these vehicles in real-time as changes to pricing of a property of the vehicle or a secondary cost parameter may influence the pricing of other properties and/or other secondary cost parameters.

Another capability involves the deployment of script editor logic (described below) supporting a defined, custom scripting language that allows an administrator of the automated pricing system 110 to express complex decision trees that reference geographic, vehicle, tax, and environment attributes to define a pricing scheme for placement into a database operating similar to either a relational database or a flat file database. This allows for virtually instantaneous pricing updates based on changes in pricing of particular vehicle components, taxes, environmental fees or other costs (or credits) associated with a particular region. It is contemplated that attributes may be updated and/or amended automatically by polling sources for changes to vehicle component pricing since the last update or for changes to secondary costs as provided by third-party servers.

Another capability involves the deployment of component pricing logic that allows the consumer to price vehicle components by market and/or by price type. Vehicle components can be variably priced based on the selection of other vehicle components as well as fluctuations in local currencies. Yet another capability is directed to deployment of script validation logic and a script compiler to optimize scripts for runtime computations.

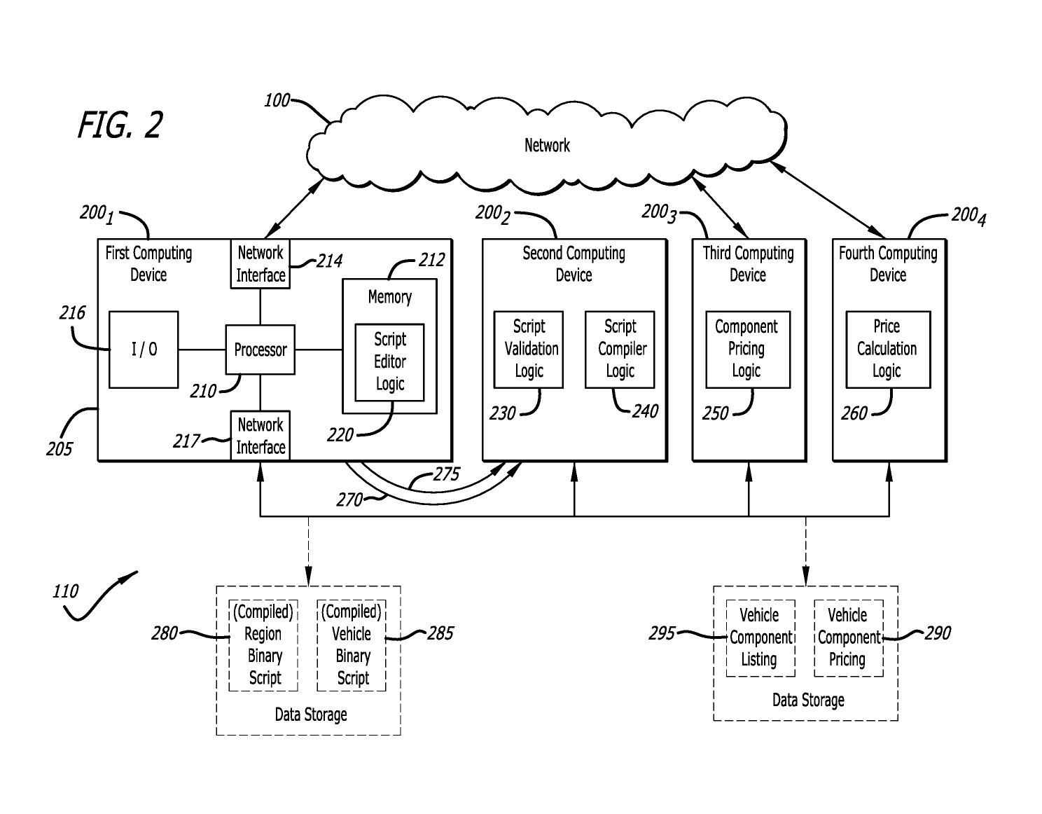

Referring now to FIG. 2, an exemplary block diagram of a logical representation of the automated pricing system 110 of FIG. 1, which comprises one or more computing devices 200₁-200_{M} (M≧1) that collectively feature (i) script editor logic 220, (ii) script validation logic 230, (iii) script compiler logic 240, (iv) component pricing logic 250, and (v) price calculation logic 260. Herein, the computing devices 200₁-200_{M} provide workload distribution for the above-identified logic. It is contemplated that other workload distribution configurations may be used for the automated pricing system 110, including placement of some or all of the above- identified logic within the same computing device (e.g., a centralized mainframe or server), where the logic is executed by one or more processors within the same computing device.

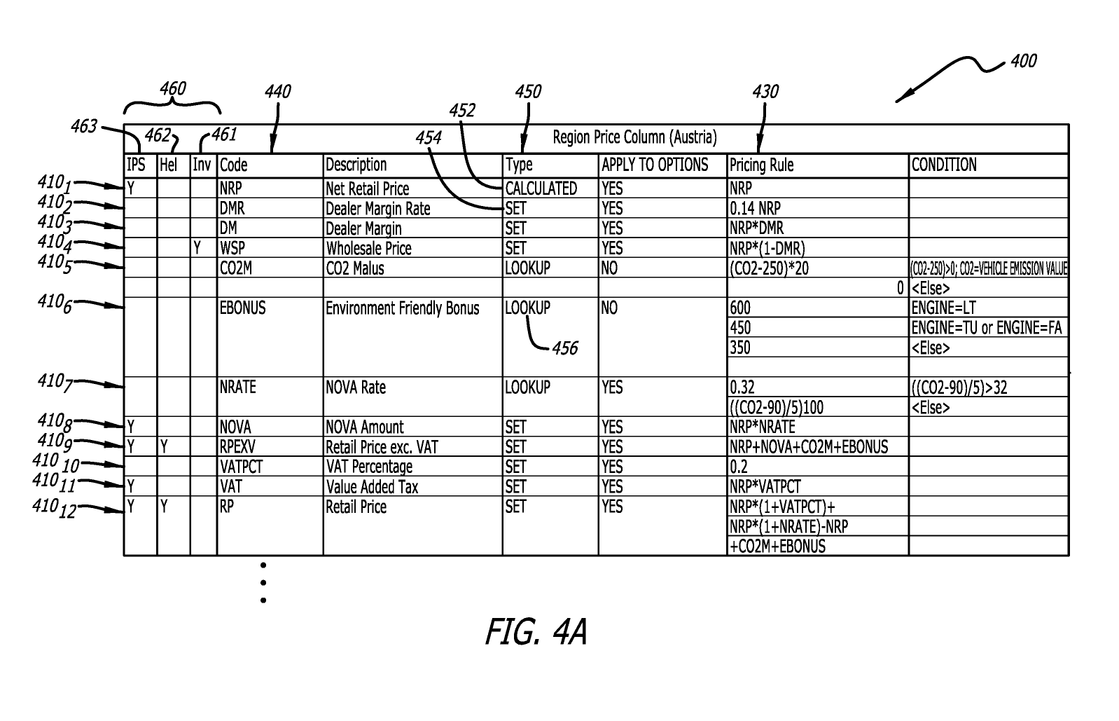

As shown, a first computing device 2001 is configured to support the script editor logic 220. The script editor logic 220 is configured with a graphics user interface (GUI) and auto completion functionality (described below) for generation of one or more price aggregation sets. These price aggregation sets may include a region-based price aggregation set 400 of FIG. 4A and/or a vehicle-based price aggregation set 470 of FIG. 4B. Each price aggregation set 400 or 470 comprises one or more records, each record being adapted to reference a stored vehicle characteristic, geographical location, and/or environment characteristics. Also, each record may be adapted to include a pricing rule, where the pricing rule may feature a relationship between other pricing rules for a particular region.

Herein, each region-based price aggregation set 400 corresponds to a “region” pricing script 270 produced by the script editor 220, namely a configuration file that defines one or more records and corresponding pricing rules to calculate vehicle pricing for that particular region. Similarly, each vehicle-based price aggregation set 470 corresponds to a “vehicle” pricing script 275 produced by the script editor 220, namely a configuration file that defines one or more records and corresponding pricing rules to calculate additional pricing for a specific vehicle for sale within that particular region.

After validation and compilation (described below), the above-identified pricing scripts 270 and 275 (now in the form of a binary script) may be used by the price calculation logic 260 for real-time generation of pricing for a (queried) built vehicle.

Although not shown in FIG. 2, other computing devices 200₂-200₄ may be implemented with processor(s), memory, network interface(s) and/or I/O similar as the first computing device 200₁. The functionality may be different, as shown in FIG. 2 where a second computing device 200₂ is configured to support (i) script validation logic 230 and (ii) script compiler logic 240. Herein, script validation logic 230 is a pre-compiler, which is configured to validate one or more “region” pricing scripts 270 (notably the scripts associated with the pricing rules and/or conditions therein) and/or one or more “vehicle” pricing scripts 275 (notably scripts associated with the pricing rules and/or conditions therein) to confirm that these pricing scripts do not have invalid references, circular loops, unattainable paths, or invalid syntax. Additionally, in order to create a high performance evaluation system, the script compiler logic 240 will convert the one or more “region” pricing scripts 270 and/or “vehicle” pricing scripts 275 into a binary encoded machine readable format (referred to as “region binary script” 280 and “vehicle binary script” 285). This allows for high performance evaluation at runtime.

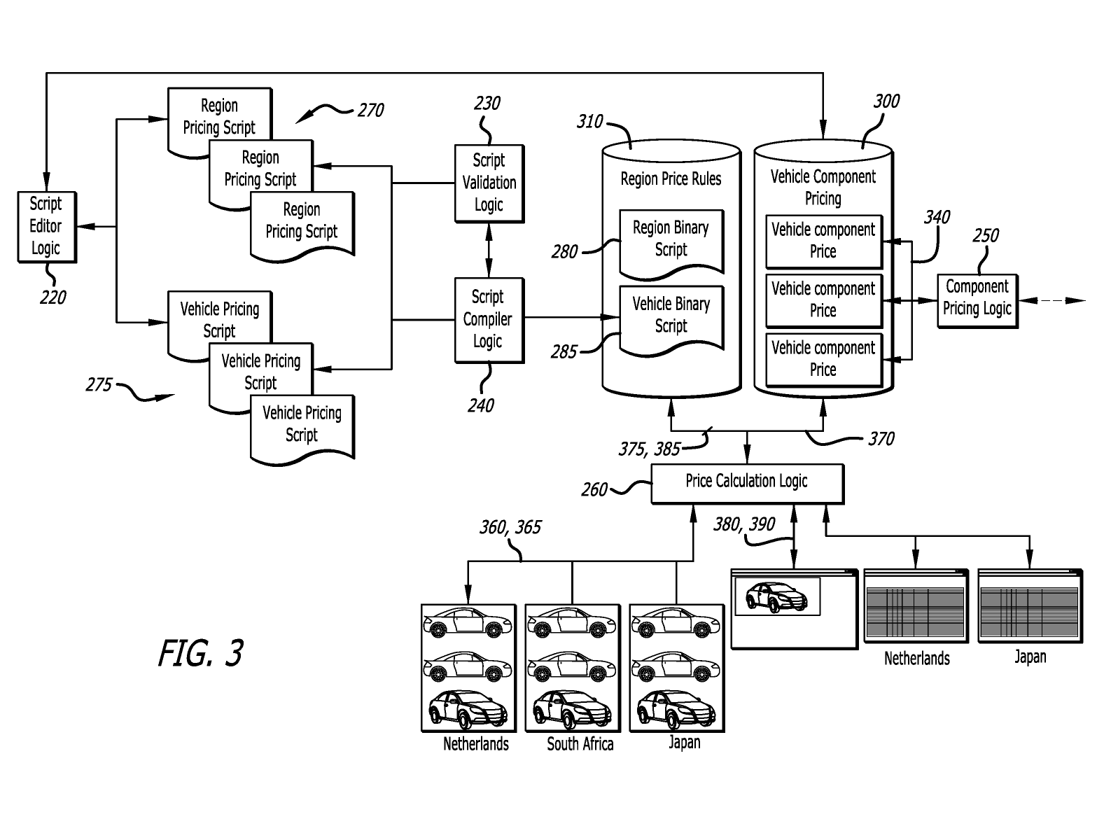

A third computing device 2003 is configured to support component pricing logic 250 that is adapted to passively or actively manage vehicle component pricing. A vehicle is composed of many components. Some vehicle components are standard equipment on certain trims of a vehicle, and some are optional upgrades to the standard condition. The component pricing logic 250 receives assigned pricing 290 for each individual vehicle component for storage (see FIG. 3). The receipt of the vehicle component pricing may be acquired passively through periodic or aperiodic uploads one or more sources responsible for the pricing information (e.g., division of global vehicle manufacturer, original equipment manufacturers “OEM”), although the component pricing logic 250 may retrieve the vehicle component pricing actively through a periodic or aperiodic polling mechanism.

It is contemplated that the component pricing logic 250 may be configured to take into account variable pricing, where the pricing is defined variably based on the presence of other components on the vehicle. For instance, leather seats may cost $800 USD in North America if the vehicle includes a BOSE® stereo system, but if not, the leather seats may cost $1,600 USD. This takes into account pricing reductions due to reduced labor, materials, or the like realized from the installation of a particular vehicle component. The component pricing logic 250 may be automatically updated by polling one or more servers (or received pushed information from the server(s)), where the updates may cause pricing changes to the vehicle due to increased/decreased material costs, labor costs, price reductions from multiple component installation, etc.

Referring still to FIG. 2, a fourth computing device 2004 is configured to support the price calculation logic 260 that is adapted as a runtime interface. The price calculation logic 260 calculates pricing of the built vehicle in any geography supported by the automated pricing system 110 (in sub-second response time). Such calculation may involve the decoding of the vehicle identification number (VIN) to recover a vehicle version identifier. Using the vehicle version identifier, the vehicle components associated with the built vehicle may be ascertained from a listing 295 and an aggregate (sum) of the pricing for each of the vehicle components may be determined. This aggregate pricing (with an optional application of a multiplier >1.0 to one or more vehicle component prices) corresponds to a base price for the vehicle (e.g., net retail price, wholesale price, etc.).

The price calculation logic 260 relies on execution of the region binary script (e.g., the compiled pricing rules and conditions originally set forth in price aggregation set 400 of FIG. 4A) to receive the aggregate pricing information, where the vehicle base price may be fetched or uploaded into the region binary script 280 (along with any additional costs associated with the vehicle binary script 285) to compute an aggregate pricing list for the vehicle being sold within the particular region. Of course, instead of a VIN, other identifiers (e.g., specific OEM codes, Year/Make/Model/Trim+options, etc.) may be used to determine the vehicle base price. Alternatively, in lieu of or in addition to the vehicle base price, it is contemplated that component pricing and metadata associated with the components may be provided to the region binary script 280 and/or vehicle binary script 285 as parameters during execution.

The price calculation service 260 further operates to enable reverse engineering of component pricing based, at least in part, on taxes and environment fees, in order to calculate all the variations in price of a single component based on price, environment, and tax rules.

With respect to the internal architecture, each computing device 2001, such as computing device 200₁ for example, illustratively includes at least one hardware processor 210, a memory 212, one or more network interfaces (referred to as “network interface(s)”) 214, and/or one or more input/output devices (referred to as “I/O device(s)”) 216, some or all of which may be connected by a system interconnect 218, such as a bus. These components are at least partially encased in a housing 205, which is made entirely or partially of a rigid material (e.g., hardened plastic, metal, glass, composite, or any combination thereof) that protects these components from atmospheric conditions.

The hardware processor 210 is a multipurpose, programmable device that accepts digital data as input, processes the input data according to instructions stored in its memory, and provides results as output. One example of the hardware processor 210 may include an Intel® x86 central processing unit (CPU) with an instruction set architecture. Alternatively, the hardware processor 210 may include another type of CPU, a digital signal processor (DSP), an application specific integrated circuit (ASIC), or the like.

The I/O device(s) 216 may include various input/output (I/O) or peripheral devices, such as a storage device for example. One type of storage device may include a solid state drive (SSD) embodied as a flash storage device or other non-volatile, solid-state electronic device (e.g., drives based on storage class memory components). Another type of storage device may include a hard disk drive (HDD). Furthermore, each network interface 214 may include one or more network ports containing the mechanical, electrical and/or signaling circuitry needed to connect the computing device 200₁ to the network 100. To that end, the network interface(s) 214 may be configured to transmit and/or receive messages using a variety of communication protocols including, inter alia, TCP/IP and HTTPS.

The memory 212 may include a plurality of locations that are addressable by the hardware processor 210 and the network interface(s) 214 for storing software, which includes the script editor logic 220 and data associated therewith.

Referring now to FIG. 3, an exemplary embodiment of the operational flow of the automated pricing system 110 of FIG. 1 is shown. Herein, as described above, the automated pricing system 110 comprises (i) the script editor logic 220, (ii) the script validation logic 230, (iii) the script compiler logic 240, (iv) the component pricing logic 250, and/or (v) the price calculation logic 260. The script editor logic 220 provides a graphics user interface (GUI) with auto-completion to allow for generation of different scripts, including the region-based price aggregation set 400 and/or the vehicle-based price aggregation set 470 with pricing computations and any inter-relationship between these pricing computations for a particular region as shown in FIGS. 4A and 4B. The script editor 220 is communicatively coupled to a first data store (e.g., vehicle component pricing database) 300, which stores uploaded pricing for each vehicle component that is deployed in one or more different types of vehicles supported by the automated pricing system 110. The vehicle component prices may be used to determine vehicle base price, as described above.

Referring to FIG. 4A, the region-based price aggregation set 400 for a particular geographic region, such as Austria for example, is shown. The region-based price aggregation set 400 comprises a plurality of records 410₁-410_{M} (M≧1; M=11 for this example), each record 410ᵢ (i=1 . . . or M) corresponds to a particular pricing parameter. Some of these pricing parameters may include, but are not limited or restricted to different pricing levels such as net retail price (NRP) 410₁, dealer margin rate (DMR) 410₂, dealer margin (DM) 410₃, wholesale price (WSP) 410₄, retail price excluding VAT (RPEXV) 410₉, and/or retail price (RP) 410₁₂. Other pricing parameters may include different taxes, fees and/or credits, which may include, but is not limited or restricted to CO₂ malus (CO2M) 410₅, Environment Friendly Bonus (EBONUS) 410₆, Notification of Vehicle Arrival (NOVA) rate (NRATE) 410₇, NOVA Amount (NOVA) 410₈, VAT percentage (VATPCT) 410₁₀, and/or Value Added Tax (VAT) 410₁₁.

As further shown in FIG. 4A, each record 410₁-410_{M} comprises at least (i) a pricing rule 430₁-430_{M}, (ii) a pricing code 440₁-440_{M} representing the corresponding pricing rule 430₁-430_{M} that may be used as a script parameter for another pricing rule, (iii) an identifier 450₁-450_{M} of the type of pricing rule 430₁-430_{M}, and (iv) one or more flags 460 to selectively identify what information associated with certain records 410₁-410_{M} is to be output to a targeted destination. For instance, a first set of flags 461₁-461_{M} is shown, each representing, when set, corresponding pricing information to be sent to a first targeted destination (e.g. wholesale price information to an invoicing department). A second set of flags 462₁-462_{M} is shown, each representing, when set, corresponding pricing information (e.g., retail price excluding VAT and retail price with VAT) to be sent to a second targeted destination, which may be different than the first targeted destination. Lastly, a third set of flags 463₁-463_{M} is shown, each representing, when set, corresponding pricing information to be sent to a third targeted destination (e.g., net retail price, NOVA amount, retail price excluding VAT, VAT, and retail price with VAT to the dealer for placement on a window sticker for example). Additional flags can be defined for additional destinations as required by the client.

In general, each pricing rule 430₁-430_{M} may comprise a static value, a script that utilizes one or more pricing codes associated with other pricing rule(s), characteristics of the vehicle (product) that is being priced, or other geographical functions (e.g., exchange rates, environment specific destination tax imposed for movement of a vehicle to a particular dealer, etc.). More specifically, each pricing rule 430₁-430_{M} may be represented in accordance with one of a plurality of rule type identifiers, labeled herein as “Calculated”, “Set” or “LookUp”.

The “Calculated” rule type identifier 452, when set, identifies the value of a corresponding pricing rule 430₁-430_{M} that is sourced from a vehicle component pricing database or determined from data within the vehicle component pricing database (described below). The “Set” rule type identifier 454, when set, identifies that the corresponding pricing rule is based on a single computation (e.g., a single value, a factor that is based on one or more other pricing rules which is represented by their code values). Lastly, the “LookUp” rule type identifier 456, when set, identifies that the pricing rule is based on one or more conditions. For instance, for EBONUS 410₆, a six-hundred euro ( [symbol] ) fee is added to the overall cost of the vehicle with a gas engine. Alternatively, a 450 [symbol] fee is added to the overall cost of hybrid or diesel engine vehicles, or else other vehicles (e.g., all electric vehicles) experience a 300 [symbol] fee.

The auto-completion functionality of the script editor 220 is designed so that, during configuration of certain pricing parameters, entries are at least initially set to a default value or limited to particular recognized system variables, namely variables associated with vehicle components that are recognized as valid inputs. For instance, when configuring the EBONUS fee 410₆, the conditions associated with the pricing rules are directed to certain engine types. Therefore, in response to entry (or update) of conditions associated with the pricing rule 430₆, a listing of system variables (e.g., “LT” for gas, “TU” for diesel, “FA” for hybrid, and “EE” electric) may be provided as a pull-down menu (with limited options for entry) to assist in completion of the script condition. The auto-completion functionality may be used for each field 430ᵢ/440ᵢ/450ᵢ/460ᵢ) of the record 410ᵢ.

Referring to FIG. 4B, the vehicle-based price aggregation set 470 for a particular vehicle is shown. The vehicle-based price aggregation set 470 provides the ability to define price parameters for a particular vehicle. The same price types can be defined, and price sets can refer to price parameters in the region vehicle set FIG. 4A. For instance, for a Nissan® LEAF®, the vehicle may be configured with any one of three battery packages 480, 482 or 484. Dependent on the selected battery package, different CO₂ malus fees (282, 175, 282) may be assigned, respectively.

Referring back to FIG. 3, based on the price aggregation set (e.g., the region-based price aggregation set 400 of FIG. 4A and/or the vehicle-based price aggregation set 470 of FIG. 4B), the script editor 220 provides one or more region pricing scripts 270 and/or one or more vehicle pricing scripts 275 to the script validation logic 230. The script validation logic 230 is a pre-compiler that validates the region pricing script(s) 270 (along with scripts associated with the pricing rules therein) and/or vehicle pricing script(s) 275 (along with scripts associated with the pricing rules therein). The script validation logic 230 confirms that these pricing scripts do not have invalid references, circular loops, unattainable paths, or invalid syntax. Thereafter, for improved performance at runtime, the script compiler logic 240 is adapted to convert the region-based price aggregation set 400 and/or the vehicle-based price aggregation set 470 into a binary encoded machine readable format that is stored as region binary script 280 and/or vehicle binary script 285 in a second data store (e.g., region price rules database) 310.

Referring still to FIG. 3, the component pricing logic 250 is adapted to passively or actively access the pricing of different vehicle components 340 for subsequent storage with the vehicle component pricing database 300. More specifically, the component pricing logic 250 receives assigned pricing for individual components 340 for built vehicles that are to be sourced by the vehicle component pricing database 300. The receipt of the vehicle component pricing 340 may be acquired passively through periodic or aperiodic uploads from original equipment manufacturers (OEMs), although the component pricing logic 250 may fetch the vehicle component pricing 340 actively through a periodic polling mechanism or an aperiodic polling mechanism that is triggered in response to an event (e.g., new model releases, per unit cost increases, calendared sales event, increased liquidation of increased inventory, etc.). It is contemplated that the component pricing logic 250 also may be configured to conduct variable pricing, where certain vehicle component pricing is defined variably based on the presence of other components on the vehicle.

As still shown in FIG. 3, the price calculation logic 260 is adapted as a runtime interface. The price calculation logic 260 calculates pricing of the built vehicle in any geography in real-time. More specifically, according to one embodiment of the disclosure, the price calculation logic 260 is adapted to receive a price assessment query message 360, and using the component pricing, compiled region script and compiled vehicle script will output a response message 365 with detailed, overall aggregate pricing of the product for that particular geographic region.

As an example, the price calculation logic 260 receives the price assessment query message 360, which includes a vehicle identification number (VIN) for the queried vehicle for pricing and a region in which the purchase (e.g., sale, lease, rent-to-own, etc.) is to occur. In response to receipt of the price assessment query message 360, the price calculation logic 260 conducts a VIN-to-vehicle version decode in order to recover a vehicle version identifier 370. Using the vehicle version identifier 370, pricing for each of the vehicle components associated with the built vehicle may be ascertained from the vehicle component pricing database 300 and a first aggregate (sum) of their vehicle component pricing 340 may be determined. This first aggregate pricing (with an optional application of a multiplier >1.0) may correspond to the vehicle base price (e.g., net retail price, wholesale price, etc.), which is accessible to the binary script 280 during execution. As described above, alternatively or in combination with the aggregate pricing, the component pricing for the built vehicle and metadata associated with the components (e.g., engine=TU, diesel, etc.) may be provided, where the metadata may operate as parameters for the compiled pricing rules/conditions within the region binary script 280 and the vehicle binary script 285.

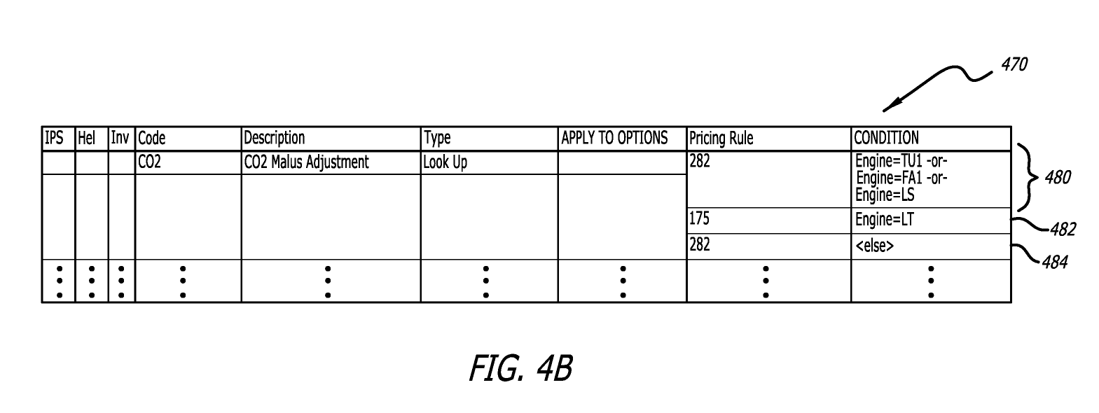

As a result of the execution of the region binary script 280 and the vehicle binary script 285 (when appropriate), the price calculation logic 260 receives a second aggregate pricing, namely a detailed pricing array 375 for the vehicle, for inclusion in the response message 365. As shown in FIG. 5, the pricing array 375 may include, but is not limited or restricted to the pricing parameters identified in each record of the region-based price aggregation list 400 of FIG. 4A. The pricing array 375 may further include additional savings or costs (taxes or fee), such as local exchange rates and/or inter-dealer transfer costs for example, that may influence the overall (retail) price of the vehicle. Some of all of the items in the detailed pricing array 375 may be imported for display.

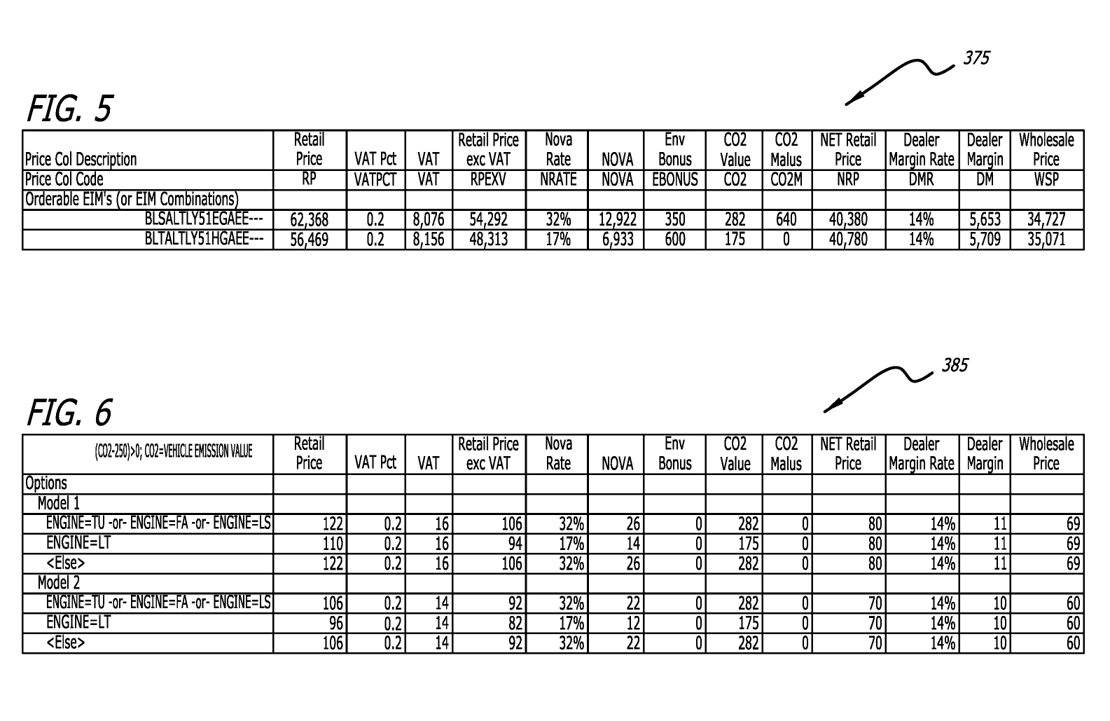

Additionally, or in the alternative to the price assessment query message 360, a second price assessment query message 380 may be received from an external source by the price calculation logic 260. The second price assessment query message 380 comprises a sequence of data that identifies the vehicle (e.g., VIN) and a list of selected features of the vehicle for pricing, along with the geographic region upon where the vehicle will be sold. Using the vehicle identifier, the price calculation logic 260 is configured to access the vehicle component pricing database 300 to determine the vehicle base price as described above and vehicle component pricing 340 associated with the selected features. The price calculation logic 260 triggers execution of the region binary script 280 and/or vehicle binary script 285, as described above, which causes generation and return of the price array 375 of FIG. 5 and pricing for the selected features 385 (as shown in FIG. 6) for inclusion in a response message 390 back to the external source.

It is contemplated that the pricing of different vehicle components 340 associated with the vehicle identified in the VIN (or data sequence) may be returned. This allows the user to understand the costs associated with the components forming the vehicle. Also, such data may be instrumental in pricing of used vehicles.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. An automated pricing system, comprising:
one or more processors; and
a memory communicatively coupled to the one or more processors, the memory comprises logic that, when executed by the one or more processors, generates an overall pricing for a product in real-time based on properties of the product and a geographic region in which a purchase of the product is to occur that are extracted from an incoming message over a network including an identifier of the product and an identifier of the geographic region.

2. The automated pricing system of claim 1, wherein the product is a vehicle.

3. The automated pricing system of claim 2, wherein the logic to receive the properties of the vehicle and the region in which the purchase of the vehicle is to occur is extracted from a price assessment query message received over the network that includes (i) the vehicle identification number (VIN) of the vehicle operating as the identifier of the vehicle and (ii) information that identifies the geographic region in which the purchase of the vehicle is to occur.

4. The automated pricing system of claim 2, wherein the logic includes script editor logic that is configured to generate a plurality of price aggregation sets including a first price aggregation set being a configuration file that defines pricing rules to calculate pricing for the vehicle when purchased within the geographic region uniquely associated with the first price aggregation set.

5. The automated pricing system of claim 4, wherein the logic further comprises script compiler logic that converts the first price aggregation set into a binary script and price calculation logic that triggers execution of the binary script by the one or more processors.

6. The automated pricing system of claim 5, wherein the script editor logic automatically polls for a change in a value of one or more parameters forming one or more of the pricing rules included in the first price aggregation set, and in response to detecting the change in the value of the one or more parameters, generating an updated configuration file with updated pricing rules that is automatically converted into an updated binary script by the script compiler logic.

7. The automated pricing system of claim 2, wherein the logic includes price calculation logic that, when executed by the one or more processors, is configured to (i) decode the identifier of the vehicle extracted from the received incoming message to recover a vehicle version identifier, (ii) determine components associated with the vehicle based on the vehicle version identifier, (iii) determine a first aggregate pricing for the vehicle based on the pricing associated with the components associated with the vehicle, and (iv) determine a second aggregate pricing for the vehicle based on pricing parameters associated with the region, the pricing parameters include taxes and credits based on the first aggregate pricing and the components associated with the vehicle.

8. The automated pricing system of claim 7, wherein the pricing parameters include value added tax that is based at least in part on the first aggregate pricing for the vehicle and Carbon Dioxide (CO₂) malus tax based on one or more components of the components associated with the vehicle.

9. The automated pricing system of claim 8, wherein the pricing parameters include credits based on the one or more components.

10. An automated pricing system, comprising:
a first data store including cost information and metadata for components of a plurality of vehicles, the cost information and metadata for each component being referenced by at least one identifier of a vehicle including the component;
a second data store including one or more binary scripts that include pricing rules to calculate secondary cost information in response to a purchase of the vehicle in a particular geographic region, the secondary cost information incurred in response to the purchase of the vehicle in the particular geographic region includes any of (i) taxes incurred for purchase of the vehicle in the particular geographic region, (ii) credits incurred for purchase of the vehicle in the particular geographic region, or (iii) fees increasing a total cost of the vehicle to secure a prescribed margin rate; and
one or more computing devices communicatively coupled to the first data store and the second data store, the one or more computing devices comprises
one or more processors, and
a memory communicatively coupled to the one or more processors, the memory comprises logic that, when executed by the one or more processors, generates an overall pricing for the vehicle in real-time based on an aggregate of the cost information for each component of the vehicle and the secondary cost information incurred in response to the purchase of the vehicle in the particular geographic region.

11. The automated pricing system of claim 10, wherein the logic of the one or more computing devices is configured to obtain the cost information and the metadata associated with components of the vehicle and the secondary cost information in response to receiving a price assessment query message that includes a vehicle identification number (VIN) of the vehicle that operates as the identifier of the vehicle or is used to obtain the identifier of the vehicle and information that identifies the particular geographic region.

12. The automated pricing system of claim 11, wherein the logic of the one or more computing devices includes script editor logic that is configured to generate a plurality of price aggregation sets including a first price aggregation set being a configuration file that defines pricing rules to calculate pricing for the vehicle when purchased within the particular geographic region, the pricing rules of the configuration file corresponding to the pricing rules of the one or more binary scripts.

13. The automated pricing system of claim 12, wherein the logic of the one or more computing devices further comprises (i) script compiler logic that converts the pricing rules of the first price aggregation set into a first binary script of the one or more binary scripts and (ii) price calculation logic that triggers execution of the first binary script by the one or more processors.

14. The automated pricing system of claim 11, wherein the logic of the one or more computing devices includes price calculation logic that, when executed by the one or more processors, is configured to (i) decode information extracted from the received price assessment query message to recover the VIN, (ii) determine components associated with the vehicle based on the VIN, (iii) determine a first aggregate pricing for the vehicle based on the cost information associated with the components of the vehicle, and (iv) determine a second aggregate pricing for the vehicle based on the secondary cost information associated with the particular geographic region, and (v) determine the overall pricing for the vehicle based on the first aggregated pricing and the second aggregated pricing.

15. The automated pricing system of claim 14, wherein the taxes associated with the secondary cost information include value added tax that is based at least in part on the first aggregate pricing for the vehicle and Carbon Dioxide (CO₂) malus tax based on one or more components of the components associated with the vehicle.

16. An automated pricing method, comprising:
receiving a price assessment query message that includes an identifier of a product and a geographic region in which a purchase of the product is to occur;
determining components associated with the product based on information associated with the identifier of the product;
determining a first aggregate pricing for the vehicle based on pricing for each of the components associated with the product;
determining a second aggregate pricing for the product based on pricing parameters associated with the geographic region, the pricing parameters include taxes and credits based on the first aggregate pricing and the components associated with the product; and
determining an overall purchase price of the product based on the first aggregate pricing and the second aggregate pricing.
